(19) United States
(12) Patent Application Publication
(10) Pub. No.: US 2017/0006096 A1
(43) Pub. Date: Jan. 5, 2017

(54) DATA BLOCK TRANSMISSION

(71) Applicant: HEWLETT PACKARD ENTERPRISE DEVELOPMENT LP, Houston, TX (US)

(72) Inventor: Stanley Neil Foster, Wixom, MI (US)

(21) Appl. No.: 15/105,053

(22) PCT Filed: Dec. 18, 2013
(86) PCT No.: PCT/US2013/076313

§ 371 Date: Jun. 16, 2016

(51) Int. Cl. H04L 29/08

(52) U.S. Cl. CPC H04L 67/1095; H04L 67/1097; H04L 67/06

(57) ABSTRACT

Disclosed herein are a system, non-transitory computer readable medium and method for synchronizing files. Files are transmitted from a source to a destination computer. A particular data block is transmitted to the destination computer, if the particular data block occurs more than once across the files in the source computer.

### BACKGROUND

Distributed file systems may be used to store redundant versions of files across a plurality of networked computers. Synchronization techniques may be used to ensure that changes are replicated across copies of the files stored in the network.

### BRIEF DESCRIPTION OF THE DRAWINGS

FIG. 1 is a block diagram of an example system in accordance with aspects of the present disclosure.

FIG. 2 is a flow diagram of an example method in accordance with aspects of the present disclosure.

FIG. 3 is a working example in accordance with aspects of the present disclosure.

FIG. 4 is a further working example in accordance with aspects of the present disclosure.

### DETAILED DESCRIPTION

As noted above, synchronization techniques may be used to replicate changes to a file in one network location to a copy of a file residing in another network location. Conventional synchronization may involve transmitting the changed file across the network and overwriting the redundant copy of the file with the new version. While the foregoing technique may be suitable for some data distribution systems, it may not be adequate for globally distributed systems with very large files. In this instance, replication of these files may cause severe network delays that may stall the entire system. By way of example, computer aided design (“CAD”) files may be very large due to the three dimensional representation of the data therein. Transferring such files from a network location in North America to another in Australia may impair an entire network's performance.

In view of the foregoing, disclosed herein are a system, non-transitory computer readable medium and method for synchronizing files. In one example, files may be transmitted from a source to a destination computer. In a further example, a particular data block may be transmitted to the destination computer, if the particular data block occurs more than once across the files in the source computer. Thus, rather than transmitting several files across the network, a data block may be transmitted to preserve network bandwidth, if the data block occurs more than once across the stored files. The aspects, features and advantages of the present disclosure will be appreciated when considered with reference to the following description of examples and accompanying figures. The following description does not limit the application; rather, the scope of the disclosure is defined by the appended claims and equivalents.

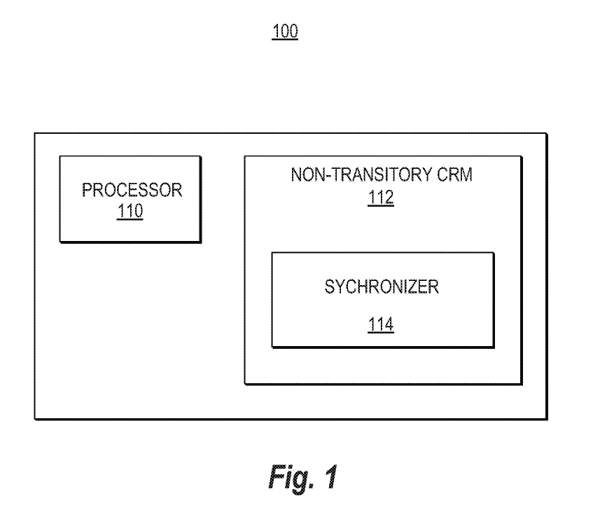

FIG. 1 presents a schematic diagram of an illustrative computer apparatus 100 for executing the techniques disclosed herein. Computer apparatus 100 may include all the components normally used in connection with a computer. For example, it may have a keyboard and mouse and/or various other types of input devices such as pen-inputs, joysticks, buttons, touch screens, etc., as well as a display, which could include, for instance, a CRT, LCD, plasma screen monitor, TV, projector, etc. Computer apparatus 100 may also comprise a network interface to communicate with other computers over a network. The computer apparatus 100 may also contain a processor 110, which may be any number of well known processors, such as processors from Intel® Corporation, In another example, processor 110 may be an application specific integrated circuit (“ASIC”). Non-transitory computer readable medium (“CRM”) 112 may store instructions that may be retrieved and executed by processor 110. As will be discussed in more detail below, the instructions may include a synchronizer 114. Non-transitory CRM 112 may be used by or in connection with any instruction execution system that can fetch or obtain the logic from non-transitory CRM 112 and execute the instructions contained therein.

Non-transitory CRM 112 may comprise any one of many physical media such as, for example, electronic, magnetic, optical, electromagnetic, or semiconductor media. More specific examples of suitable non-transitory CRM include, but are not limited to, a portable magnetic computer diskette such as floppy diskettes or hard drives, a read-only memory (“ROM”), an erasable programmable read-only memory, a portable compact disc or other storage devices that may be coupled to computer apparatus 100 directly or indirectly. Alternatively, non-transitory CRM 112 may be a random access memory (“RAM”) device or may be divided into multiple memory segments organized as dual in-line memory modules (“DIMMs”). The non-transitory CRM 112 may also include any combination of one or more of the foregoing and/or other devices as well. While only one processor and one non-transitory CRM are shown in FIG. 1, computer apparatus 100 may actually comprise additional processors and memories that may or may not be stored within the same physical housing or location.

The instructions of synchronizer 114 residing in non-transitory CRM 112 may comprise any set of instructions to be executed directly (such as machine code) or indirectly (such as scripts) by processor 110. In this regard, the terms “instructions,” “scripts,” or “modules” may be used interchangeably herein. The computer executable instructions may be stored in any computer language or format, such as in object code or modules of source code. Furthermore, it is understood that the instructions may be implemented in the form of hardware, software, or a combination of hardware and software and that the examples herein are merely illustrative.

In one example, synchronizer 114 may instruct processor 110 to transmit a plurality of files from a source computer to a destination computer. In another example, synchronizer 114 may instruct processor 110 to determine whether a particular data block occurs more than once across the plurality of files in the source computer due to a change to the files. In yet a further example, synchronizer 114 may instruct processor 110 to transmit the particular data block to the destination computer, if the particular data block occurs more than once across the plurality of files due to the change.

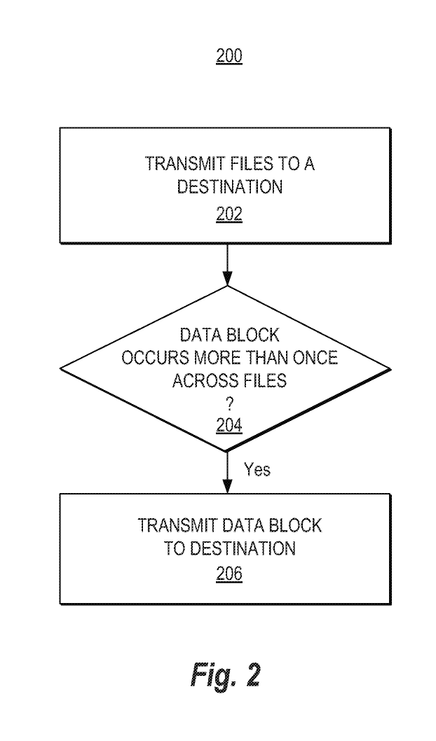

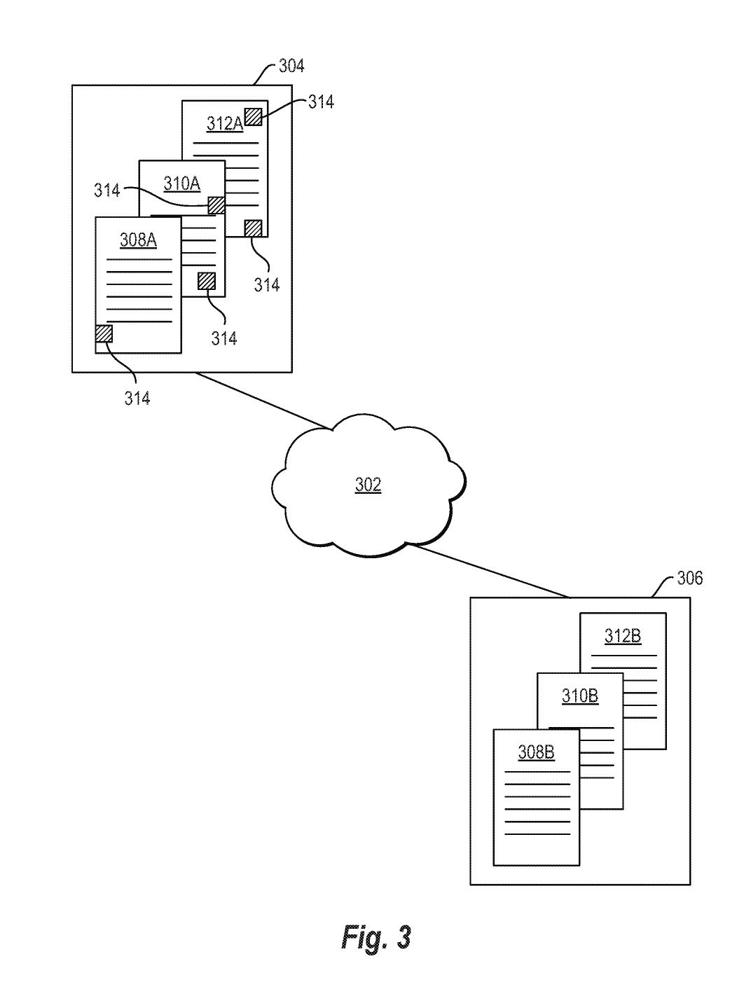

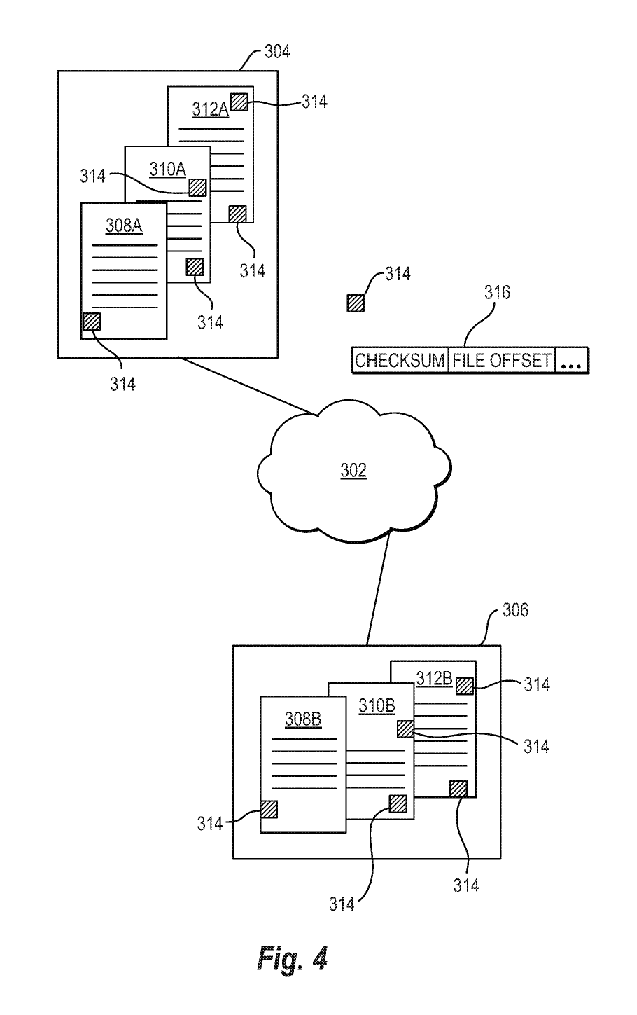

Working examples of the system, method, and non-transitory computer readable medium are shown in FIGS. 2-4. In particular, FIG. 2 illustrates a flow diagram of an example method 200 for synchronizing files. FIGS. 3-4 each show a working example in accordance with the techniques disclosed herein. The actions shown in FIGS. 3-4 will be discussed below with regard to the flow diagram of FIG. 2.

As shown in block 202 of FIG. 2, a plurality of files may be transmitted from a source computer to a destination computer. Referring now to FIG. 3, a plurality of computers, including source computer 304 and destination computer 306, are shown communicating over a network 302. The computers 304 and 306 may be similar to computer 100 shown in FIG. 1. Alternatively, any one of the computers 304 and 306 may comprise a plurality of computers, such as a load balancing network. Network 302 and intervening nodes thereof may comprise various configurations and use various protocols including the Internet, World Wide Web, intranets, virtual private networks, local Ethernet networks, private networks using communication protocols proprietary to one or more companies, cellular and wireless networks (e.g., WiFi), instant messaging, HTTP and SMTP, and various combinations of the foregoing. Although two computers are depicted in FIG. 3, it should be appreciated that a typical system may include a larger number of networked computers and that two computers are used for ease of illustration.

FIG. 3 also shows a plurality of files 308A, 310A, and 312A stored in source computer 304. Further, FIG. 3 shows file copies 308B, 310B, and 312B stored in destination computer 306 that correspond to files 308A, 310A, and 312A respectively. It is understood that there may be several more files than those shown in FIG. 3 and that copies of these files may be generated and transmitted to several more destination computers.

Referring back to FIG. 2, it may be determined whether a particular data block occurs more than once across the plurality of files in the source computer due to a change, as shown in block 204. Referring back to FIG. 3, changes to files 308A, 310A, and 312A may be tracked in order to detect whether a particular data block occurs more than once across the files. Each file shown in FIG. 3 may have a file size Y and may be broken down into Z number of blocks plus a remainder. Thus, the total file size Y may be sum(Z₁, Z₂, Z₃, . . . Zₙ). The initial block size may be determined through an observational or heuristic evaluation of the data sets and may be further refined holistically based on mathematical, behavioral, and data patterns.

In the example of FIG. 3, data block 314 is shown occurring five times across files 308A, 310A, and 312A. In another example, it may be determined whether the particular data block 314 in source computer 304 is different than a corresponding data block in destination computer 306 to ensure that the change to the blocks were only made to the files in the source computer. Referring back to FIG. 2, if it is determined that the data block occurs more than once across the files, the particular data block may be transmitted to the destination, as shown in block 206. In another example, information that enables insertion of the particular data block across the files held in the destination computer may also be transmitted. Such information may be between approximately sixteen bits to approximately thirty two bits in length and may include a checksum associated with the data block. Furthermore, the information may contain file offset information for each file in which the data block will be inserted to ensure proper synchronization of the files.

Referring now to FIG. 4, a single copy of data block 314 and its associated information 316 is shown being transferred across network 302 to destination computer 306. Upon receipt, information 316 may be used to validate data block 314 via the checksum, determine which files require the updated data block, and determine the file offset for insertion into each file. FIG. 4 illustrates the insertion of data block 314 into file copies 308B, 310B, and 312B after analyzing the associated information 316.

Advantageously, the foregoing system, method, and non-transitory computer readable medium permit the synchronization of distributed files without harming the network's performance. In this regard, rather than transmitting multiple potentially large files, one copy of an altered data block may be transmitted in order to preserve network bandwidth. In turn, file synchronization may be carried out in parallel with normal network usage while going unnoticed by users of applications that rely on network performance,

Although the disclosure herein has been described with reference to particular examples, it is to be understood that these examples are merely illustrative of the principles of the disclosure. It is therefore to be understood that numerous modifications may be made to the examples and that other arrangements may be devised without departing from the spirit and scope of the disclosure as defined by the appended claims. Furthermore, while particular processes are shown in a specific order in the appended drawings, such processes are not limited to any particular order unless such order is expressly set forth herein; rather, processes may be performed in a different order or concurrently and steps may be added or omitted.

1. A system comprising:
a synchronizer which upon execution instructs at least one processor to:
transmit copies of a plurality of files from a source computer to a destination computer;
determine whether a particular data block occurs more than once across the plurality of files in the source computer due to a change to the files; and
transmit the particular data block to the destination computer, if the particular data block occurs more than once across the plurality of files due to the change
transmit information to the destination computer together with the particular data block that enables insertion of the particular data block across the copies of the plurality of files held in the destination computer.

2. (canceled)

3. The system of claim 1, wherein the information that enables insertion of the particular data block is between approximately sixteen bits to approximately thirty two bits in length.

4. The system of claim 1, wherein the information that enables insertion of the particular data block comprises a checksum value associated with the particular data block.

5. The system of claim 1, wherein the synchronizer upon execution further instructs at least one processor to determine whether the particular data block in the source computer is different than a corresponding data block in the destination computer.

6. A non-transitory computer readable medium having instructions therein which, when executed, cause at least one processor to:
generate copies of a plurality of files residing in a source computer;
transmit the copies to a destination computer;
track changes to the files in the source computer to determine whether a particular data block occurs more than once across the plurality of files in the source computer due to a change; and
transmit a single copy of the particular data block to the destination computer, if the particular data block occurs more than once across the plurality of files due to the change.

7. The non-transitory computer readable medium of claim 6, wherein the instructions therein upon execution further cause at least one processor to transmit information to the destination computer that enables insertion of copy of the particular data block across the copies of the plurality of files held in the destination computer.

8. The non-transitory computer readable medium of claim 7, wherein the information that enables insertion of the copy of the particular data block is approximately sixteen bits to approximately thirty two bits in length.

9. The non-transitory computer readable medium of claim 7, wherein the information that enables insertion of the copy of the particular data block comprises a checksum value associated with the particular data block.

10. The non-transitory computer readable medium of claim 6, wherein the instructions therein upon execution further cause at least one processor to determine whether the particular data block in the source computer is different than a corresponding data block in the destination computer.

11. A method comprising
dividing a plurality of files stored in a source computer into data blocks;
transmitting copies of the plurality of files to a destination computer;
tracking changes to the plurality of files in the source computer;
determining whether a particular one of the data blocks occurs more than once across the plurality of files in the source computer and has been altered due to a change to the plurality of files;
transmitting one updated copy of the particular one of the data blocks to the destination computer in response to determining that the particular data block occurs more than once across the plurality of files and has been altered due to the change; and
transmitting information to the destination computer that enables insertion of the updated data block in each one of the copies held in the destination computer in which the particular data block occurs.

12. (canceled)

13. The method of claim 12, wherein the information that enables insertion of the updated data block is approximately sixteen bits to approximately thirty two bits in length.

14. The method of claim 12, wherein the information that enables insertion of the updated data block comprises a checksum value associated with the particular data block.

15. The method of claim 11, further comprising determining whether the particular data block as-altered in the source computer is different than a corresponding data block in the destination computer.
